(19) United States
(12) Patent Application Publication
(10) Pub. No.: US 2024/0248826 A1
(43) Pub. Date: Jul. 25, 2024

(54) USER INTERFACE STATE MAPPING

(71) Applicant: Salesforce, Inc., San Francisco, CA (US)

(72) Inventors: Josh Philip Walker, San Francisco, CA (US); Wiiliam Hackett, Santa Rosa, CA (US); Hon Fai Ng, Dublin, CA (US); Dongkun David Kim, Jessup, MD (US); Harrison Lee Berrier, Austin, TX (US)

(21) Appl. No.: 18/101,462

(22) Filed: Jan. 25, 2023

(51) Int. Cl. G06F 11/34; G06F 8/38

(52) U.S. Cl. CPC G06F 11/3457; G06F 8/38

(57) ABSTRACT

Methods, systems, and devices supporting mapping user interface (UI) states for a web document are described. A UI state mapper program may determine a set of interactable elements that are configured to cause a UI state change to a UI of the web document, such as from a configuration for the web document. The UI state mapper program may interact with the set of interactable elements of the UI. The UI state mapper program may generate sets of nodes in a graphical node representation in response to the interacting. The sets of nodes may include nodes of a first node type with a UI state change resulting from a universal resource locator (URL) change and nodes of a second node type with a UI state change resulting from a visual effect on the UI without a URL change. The UI state mapper may generate a computer readable record indicating a sequence of interactions by the UI state mapper program to generate the graphical node representation.

### FIELD OF TECHNOLOGY

The present disclosure relates generally to database systems and data processing, and more specifically to user interface (UI) state mapping.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

Some cloud platforms—or other systems—may support user interaction with a web document via a user interface (UI). The user interaction may activate one or more features of the UI. A developer of the web document may benefit from simulating user interaction to obtain metrics or data related to the web document. However, the features of the UI may be relatively complex, such as for nested features, and tracking the simulated user interaction may be difficult. Further, there may not be techniques for identifying and recording the possible states of a UI (e.g., because of complex nested features among other challenges), and analysis of the metrics or data related to the web document may consequently be inefficient or inaccurate.

### BRIEF DESCRIPTION OF THE DRAWINGS

FIGS. 1 and 2 illustrate examples of user interface (UI) state mapping systems that support UI state mapping in accordance with aspects of the present disclosure.

FIG. 3 illustrates an example of a web document diagram that supports UI state mapping in accordance with aspects of the present disclosure.

FIG. 4 illustrates an example of a graphical node representation diagram that supports UI state mapping in accordance with aspects of the present disclosure.

FIG. 5 illustrates an example of a process flow that supports UI state mapping in accordance with aspects of the present disclosure.

FIG. 6 illustrates a block diagram of an apparatus that supports UI state mapping in accordance with aspects of the present disclosure.

FIG. 7 illustrates a block diagram of a UI state manager that supports UI state mapping in accordance with aspects of the present disclosure.

FIG. 8 illustrates a diagram of a system including a device that supports UI state mapping in accordance with aspects of the present disclosure.

FIGS. 9 and 10 illustrate flowcharts showing methods that support UI state mapping in accordance with aspects of the present disclosure.

### DETAILED DESCRIPTION

Some systems (e.g., cloud platforms or other systems) may support user interaction with one or more interactable elements of a web document, such as via a user interface (UI). In some cases, the UI may have different types of features (e.g., interactable elements), which may result in different UI states. For example, a UI may include features of a first type that experience state changes resulting from a universal resource locator (URL) change and a second type that experience state changes resulting from a visual effect on the UI without a URL change. The features of the first type may be referred to as persistent features, or persistent nodes, while the features of the second type may be referred to as transient features, or transient nodes. The state changes of each feature may occur in response to a user input via the UI, such as if the user activates the feature (clicks a link that takes the user to another page of the web document, hovers a mouse over a feature that then reveals a menu, etc.). However, the features of the UI may be relatively complex, such as for nested features, and tracking user interaction or simulated user interaction may be difficult. Further, there may not be techniques for identifying and recording the possible states of a UI (e.g., because of complex nested features among other challenges), and analysis of the metrics or data related to the web document may consequently be inefficient or inaccurate.

To simulate user interaction and to identify and record state changes, a UI state mapper program may generate nodes in a graphical node representation by interacting with the features, or interactable elements, of the web document. For example, the UI state mapper program may traverse through the features of the web document to generate the graphical node representation of the persistent nodes and the transient nodes. The UI state mapper program may record a sequence of interactions (e.g., representative of user inputs) by the UI state mapper to generate the graphical node representation, such as in a computer readable record. Thus, the UI state mapper program may obtain a computer readable record of a sequence of interactions by the UI state mapper program, which may be repeatable. For example, a developer may use the computer readable record to perform testing on the UI, obtain data related to the efficiency or accuracy of the state changes of the interactable elements of the UI, or the like, which may improve user experience related to interactions with the web document.

In some examples, the UI state mapper program may generate the graphical node representation as a tree structure with multiple sub-trees, which may be referred to as interaction paths. The UI state mapper program may implement a node traversal technique in which the UI state mapper program returns to a nearest ancestral persistent node upon reaching an end of a sub-tree, or interaction path. In some cases, the UI state mapper program may record the UI state of each interactable element, or node in the graphical node representation. For example, the UI state mapper program may obtain screenshots of a state change to display to a user (e.g., a developer of the web document) via a graphical user interface (GUI). The user may flag, tag, or otherwise indicate a privacy status of the node, a security status of the node, an accessibility status of the node, or any combination thereof via the GUI. The UI state mapper program may store, or record, the UI state, the statuses, or both in the computer readable record.

Aspects of the disclosure are initially described in the context of mapping UI states systems, web document diagrams, graphical node representation diagrams, and process flows. Aspects of the disclosure are further illustrated by and described with reference to apparatus diagrams, system diagrams, and flowcharts that relate to UI state mapping.

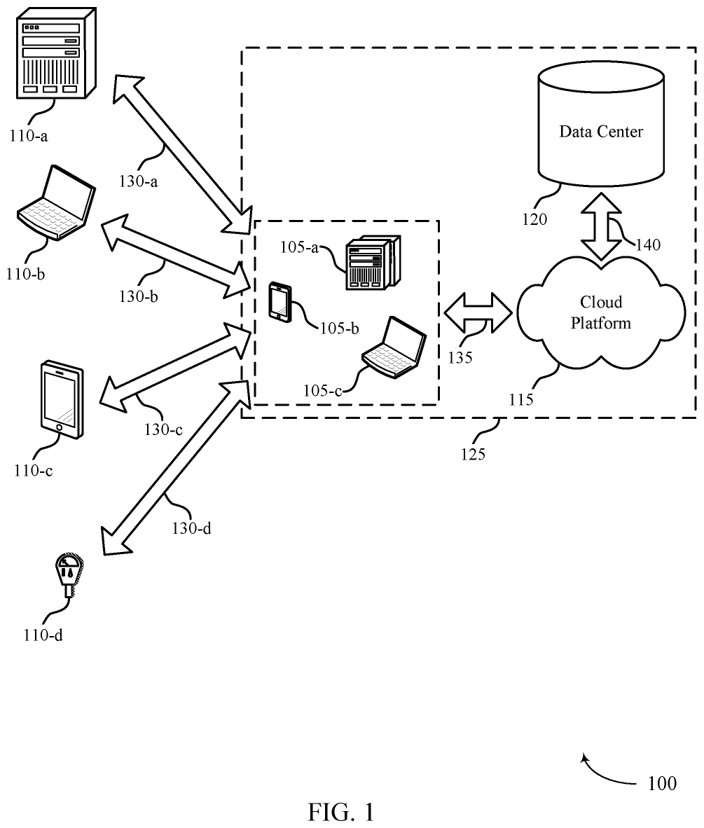

FIG. 1 illustrates an example of a system 100 for cloud computing that supports UI state mapping in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

Some systems (e.g., cloud platforms or other systems) may support user interaction with one or more interactable elements of a web document, such as via a UI. In some cases, the UI may have different types of features (e.g., interactable elements), which may result in different UI states. For example, a UI may include features of a first type that experience state changes resulting from a URL change, such as if a user clicks a link that takes the user to another page of the web document. Additionally, or alternatively, the UI may include features of a second type that experience state changes resulting from a visual effect on the UI without a URL change, such as if a user hovers a mouse over a feature that then reveals a menu. The features of the first type may be referred to as persistent features, or persistent nodes, while the features of the second type may be referred to as transient features, or transient nodes. However, the features of the UI may be relatively complex, such as for nested features (e.g., iFrames, shadow document object models (DOMs), or both), and tracking user interaction or simulated user interaction may be difficult. Further, there may not be techniques for identifying and recording the possible states of a UI (e.g., because of complex nested features among other challenges), and analysis of the metrics or data related to the web document may consequently be inefficient or inaccurate.

To simulate user interaction and to identify and record state changes, a UI state mapper program may generate nodes in a graphical node representation by interacting with the features, or interactable elements, of the web document. For example, the UI state mapper program may traverse through the features of the web document to generate the graphical node representation of the persistent nodes and the transient nodes. The UI state mapper program may record a sequence of interactions (e.g., representative of user inputs) by the UI state mapper to generate the graphical node representation, such as in a computer readable record. Thus, the UI state mapper program may obtain a computer readable record of a sequence of interactions by the UI state mapper program, which may be repeatable. For example, a developer may use the computer readable record to perform testing on the UI, obtain data related to the efficiency or accuracy of the state changes of the interactable elements of the UI, or the like, which may improve user experience related to interactions with the web document.

In some examples, a user may obtain the computer readable record to perform localization testing. For example, the UI state mapper program may output the computer readable record to the user, where the computer readable record may include a UI state. The user may compare the UI state for different versions of the web document to determine differences, which may indicate errors for the feature. For example, if a screenshot of a feature of a web document in first language is different than a screenshot of the same feature of a different version of the web document in a second language, then the user may recognize a translation error and may update the feature to be the same for both versions of the web document. In this way, the user updating the feature may improve user experience for interactions of other users with the web document.

It should be appreciated by a person skilled in the art that one or more aspects of the disclosure may be implemented in a system 100 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

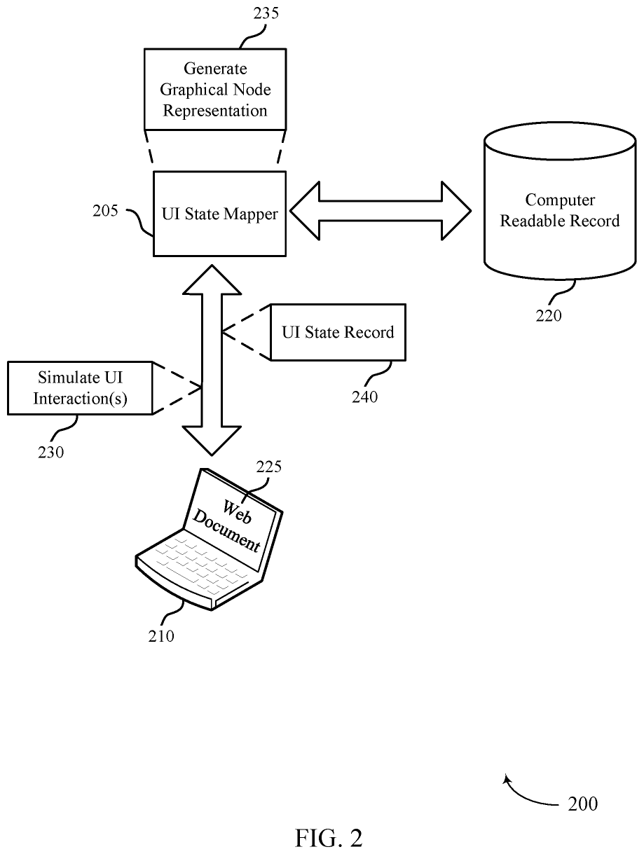

FIG. 2 illustrates an example of a UI state mapping system 200 that supports UI state mapping in accordance with aspects of the present disclosure. The UI state mapping system 200 includes a UI state mapper 205, a user device 210, and a computer readable record 220. The UI state mapping system 200 may implement aspects of a system 100 as described with reference to FIG. 1. For example, the UI state mapper 205 and/or the computer readable record 220 may be examples or components of a data center 120 and/or cloud platform 115, and the user device 210 may be an example of a cloud client 105 or a contact 110.

The UI state mapper 205 may represent aspects of an application server, communication server, data processing server, database server, cloud-based server, server cluster, virtual machine, container, or some similar data processing device or system. The UI state mapper 205 may communicate with other devices or data systems such the user device 210 and the computer readable record 220. For example, the UI state mapper 205 may interact with one or more features, or interactable elements, of a web document 225 at the user device 210 to generate a computer readable record 220 of the sequence of interactions.

In some cases, it may be relatively expensive and difficult to maintain UIs using automation tools, such as end-to-end automation tools that relate to a single user flow or interaction path within the UI, due to inconsistencies in UI states, which may make failure resolution complex and time consuming. Specifically, using end-to-end automation tools for localization testing may be inefficient because localization testing involves comparison of states across web documents 225 at the UI (e.g., comparison of screenshots at each UI feature common across web documents 225), and accessing each state to perform the comparison may be time consuming and often inaccurate due to the inconsistencies. Thus, as described herein, it may be beneficial to leverage automation tools to map UI states (e.g., in different locals for localization testing) to reduce errors in the technology and to improve user experience.

In some cases, at 230, the UI state mapper 205 may simulate one or more UI interactions, such as if a user were interacting with the UI. For example, the UI state mapper 205 may determine one or more features of a web document 225 are interactable, such as from a configuration of the web document 225. The one or more interactable features may also be referred to as interactable elements, and may include anchor tags, buttons, custom components that may be activated (e.g., clicked) by a user, or any other element that may update a URL or change a visual effect of the UI. The configuration may be stored at a database accessible by the UI state mapper 205, may be otherwise configured or defined (e.g., for an API), or may be uploaded to the UI state mapper 205 by a user. The UI state mapper 205 may activate the features, or elements, to simulate the one or more UI interactions. For example, the interactable features may include links that change a URL, where those features may be referred to as persistent features or nodes. Additionally, or alternatively, the interactable features may include commands that change a visual effect of the UI, where those features may be referred to as transient features or nodes.

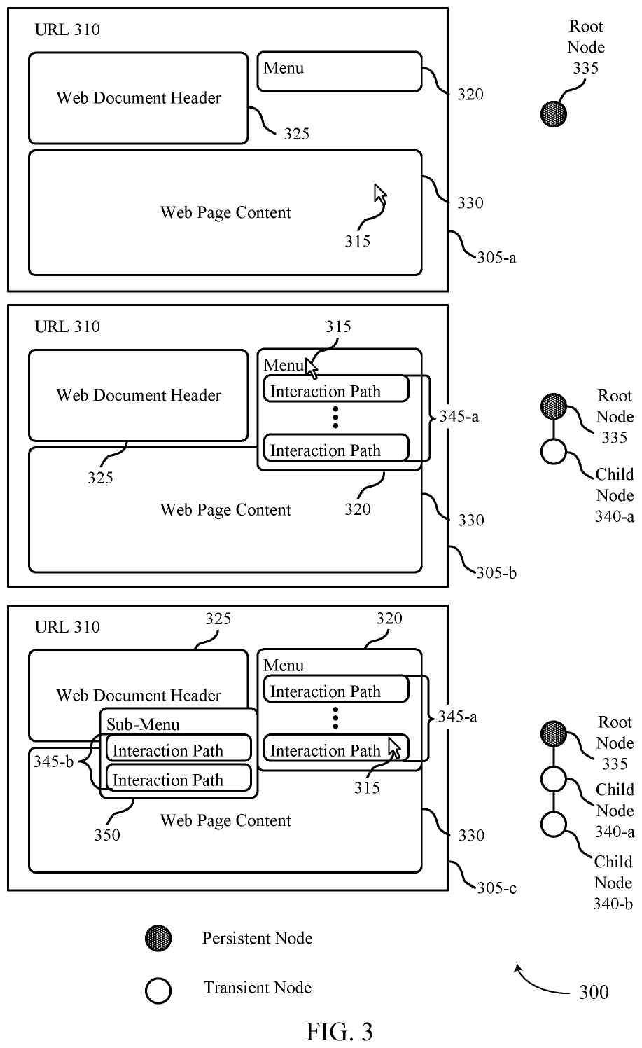

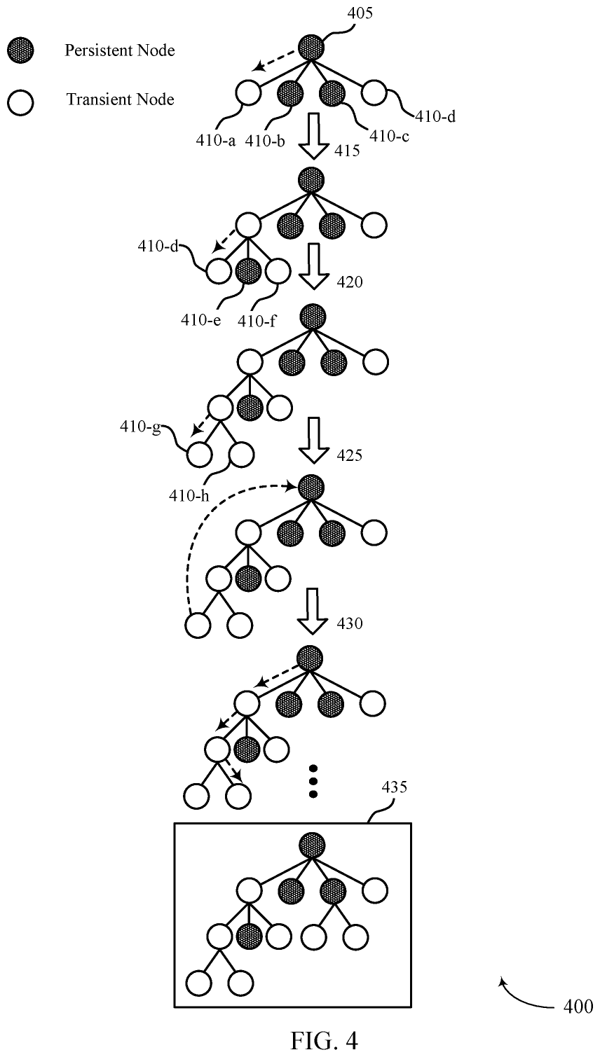

After simulating the UI interactions at 230, the UI state mapper 205 may generate a graphical node representation of the interactions at 235. The graphical node representation may be a graphical tree with the UI interactions represented as nodes and edges. The nodes may include persistent features (e.g., persistent nodes) and/or transient features (e.g., transient nodes). The generation and traversal of the graphical node representation is described in further detail with respect to FIGS. 3 and 4. Each node of the graphical node representation may represent an interaction of the UI state mapper with the UI, such that the UI state mapper may record a sequence of interactions performed to generate the graphical node representation. For example, the UI state mapper 205 may generate the computer readable record 220 that includes the sequence of interactions, such that a user or automation tool may repeat the sequence of interactions to maintain or otherwise update the UI.

In some examples, the UI state mapper 205 may obtain a UI state of a node of the graphical node representation (e.g., a state of a persistent feature or transient feature). For example, at 240, the UI state mapper 205 may obtain a UI state record from the web document 225 at the user device 210. The UI state record may be a screenshot of the UI for each node of the graphical node representation. Additionally, or alternatively, the UI state mapper 205 may display the screenshot to the user for each node (e.g., via a GUI of the user device 210). In some cases, the user may flag, or otherwise tag, the node with a privacy status, a security status, an accessibility status, or any combination thereof. In some other cases, a computer program may flag, or otherwise tag, the node independent of the user. For example, if the node presents privacy concerns (e.g., the node includes sensitive or private information), security concerns (e.g., the node may be compromised relatively easily), accessibility concerns (e.g., the child features of the node may be inaccessible), or the like, the user or the computer program may flag the node accordingly. The user or the computer program may subsequently revisit the flagged nodes to remove private information, improve security, improve accessibility, or the like.

In some cases, the UI state mapper 205 may store, or otherwise record, the UI state and any flags for nodes, where the stored UI state is linked to the computer readable record 220 based on an interaction that produced the node from the sequence of interactions. Similarly, the UI state mapper 205 may generate multiple graphical node representations of a web document 225 implemented at different locals (e.g., in a different language). The UI state mapper 205 may record the sequence of interactions, the UI state, and any flags for the multiple graphical node representations. The UI state mapper 205 may display the UI states for a sequence of interactions via a GUI of the user device 210. For example, the UI state mapper 205 may display screenshots from different locals, and a user may validate the screenshots in a localization testing procedure. The localization testing procedure may include a language expert comparing translations for the displayed screenshots from a same feature of a web document 225 that may be in two different languages (e.g., two different locals). Additionally, or alternatively, the localization testing procedure may include a user flagging the feature if the screenshots have one or more differences (e.g., one or more visual elements of a first screenshot is different than one or more visual elements of a second screenshot for a same feature).

In some cases, a user may use the computer readable record of the sequence of interactions to determine an end-to-end execution time for traversing the graphical node representation. In some other cases, the user may use the computer readable record of the sequence of interactions to obtain a heatmap for use rate (e.g., click-rate) from customers, which may in turn be relevant for risk assessment for a UI change (e.g., a representation of core customer flow). Additionally, or alternatively, the user may use the computer readable record to determine whether one or more features are functional. If the user determines the feature is not functional (e.g., the feature crashes the web document 225), then the user may update the feature to be functional.

FIG. 3 illustrates an example of a web document diagram 300 that supports UI state mapping in accordance with aspects of the present disclosure. The web document diagram 300 may illustrate an example of UI state mapping, such as for a web document in a state 305-a, a state 305-b, a state 305-c, or any other state. The web document diagram 300 may implement, or may be implemented by, the UI state mapping system 100 and the UI state mapping system 200. For example, a UI state mapper may simulate human UI interactions at a web document of a user device and may generate a computer readable record based on the simulated human UI interactions (e.g., a UI state mapper 205, a user device 210, and a computer readable record 220 as described with reference to FIG. 2).

In some examples, a UI state mapper may navigate to a web document by entering a URL 310 to a search engine on a user device. The UI state mapper may use a navigation tool 315 (e.g., a mouse that has hover and click functionalities, a keyboard, or any other input tool for the user device) to navigate to the web document. The URL 310 may activate a first feature of the web document, which may be an opening page, such as for the state 305-a. The opening page of the web document, or the first feature of the web document, may include a menu 320, a web document header 325, and web page content 330. For the state 305-a, the UI state mapper may generate a node, such as the root node 335 in a graphical node representation (e.g., a tree) in response to navigating to the web document. Because opening the web document caused a URL to change, the root node 335 may be a persistent node. Additionally, or alternatively, the UI state mapper may obtain a record of the state 305-a, such as a screenshot of the web document at the state 305-a.

In some examples, the UI state mapper may interact with a second feature of the web document, such as by hovering the navigation tool 315 over the menu 320 of the web document. The UI state mapper may represent the interaction with the second feature as a child node 340-a of the root node 335 in the graphical node representation. The action of hovering the navigation tool 315 may change a visual effect of the web document but may not change the URL 310. Thus, the child node 340-a may be a transient node. For example, the action may cause the web document to display a drop-down list from the menu 320 for a user to select one or more interaction paths 345-a. Each option in the list may be an interaction path of the one or more interaction paths 345-a, which may produce a sub-tree in the graphical node representation, which is described in further detail with respect to FIG. 4. The UI state mapper may obtain a record of the state 305-b, such as a screenshot of the web document at the state 305-b.

In some cases, the UI state mapper may interact with a third feature of the web document, such as by hovering the navigation tool 315 over an interaction path of the one or more interaction paths 345-a in the list from the menu 320 of the web document. The interaction may cause the web document to display a sub-menu 350 with one or more additional interaction paths 345-b. The interaction may not update the URL 310. Thus, the UI state mapper may represent the interaction with the third feature as a transient node that is a child node 340-b of the root node 335 in the graphical node representation. The UI state mapper may obtain a record of the state 305-c, such as a screenshot of the web document at the state 305-c.

In some examples, the UI state mapper may continue to traverse the features of the web document (e.g., the interactable elements of the web document, such as the interaction paths 345-a, the interaction paths 345-b, and any other interactable elements of the web document) to generate the graphical node representation, which is described in further detail with respect to FIG. 4. In some examples, the interactable elements may include nested, or hidden, elements of the web document, such as iFrames and shadow DOMs. Once the UI state mapper has generated the graphical node representation, the UI state mapper may generate a computer readable record of the sequence of interactions the UI state mapper took to generate the graphical node representation. With each recorded interaction, the UI state mapper may additionally, or alternatively link a UI state produced from the interaction with the web document to the respective interaction in the sequence of interactions. For example, the UI state mapper may record screenshots of the state 305-a linked to the root node 335, the state 305-b linked to the child node 340-a, and the state 305-c linked to the child node 340-b. The UI state mapper may display the states of each node to a user, such as for comparison with an equivalent state of a feature from different web documents for localization testing and/or for the user to tag the node for security, accessibility (e.g., accessibility compliance), privacy, or any other aspect of the feature. The user may also use the information from the computer readable record to detect errors in the web document, obtain information regarding user interaction heat-maps, obtain end-to-end execution duration of the interactions, or the like.

FIG. 4 illustrates an example of a graphical node representation diagram 400 that supports UI state mapping in accordance with aspects of the present disclosure. The graphical node representation diagram 400 may illustrate an example of UI state mapping for one or more interactable elements, or features, of a web document. The graphical node representation diagram 400 may implement, or may be implemented by, the UI state mapping system 100, the UI state mapping system 200, and the web document diagram 300. For example, a UI state mapper may simulate human UI interactions at a web document of a user device and may generate a graphical node representation 435 based on the simulated human UI interactions (e.g., a UI state mapper 205, a user device 210, and a computer readable record 220 as described with reference to FIG. 2).

In some examples, a UI state mapper may determine that a web document has one or more interactable elements that may cause a UI state change to a UI of the web document. For example, the UI state mapper may use a configuration for an API of the web document, may be configured with the interactable elements, may receive an indication of the interactable elements, or the like. The UI state mapper may interact with the set of interactable elements to simulate human UI interaction, such as by activating one or more persistent feature, transient features, or both to generate persistent nodes and transient nodes of the graphical node representation 435. For example, as described with reference to FIG. 3, the UI state mapper may navigate to a URL of a web document and may generate a root node 405 based on (e.g., after) navigation to the URL. From the opening page of the web document, the UI state mapper may traverse the features of the web document to generate the graphical node representation 435.

For example, the UI state mapper may traverse from the initial feature to a feature that changes a visual representation of the web document (e.g., hovering a mouse over a drop-down menu). The UI state mapper may generate a child node 410-a, a child node 410-b, a child node 410-c, and a child node 410-d based on interacting with the feature that changes the visual representation. For example, the child node 410-a, the child node 410-b, the child node 410-c, and the child node 410-d may be interaction paths in a list from a menu. Some of the interaction paths in the list may generate persistent nodes (e.g., change a URL when interacted with), while others may generate transient nodes (e.g., change a visual effect, but not the URL).

The UI state mapper may systematically traverse each of the interaction paths generated by the child node 410-a, the child node 410-b, the child node 410-c, and the child node 410-d. For example, at 415, the UI state mapper may traverse from the root node 405 to the child node 410-a. The feature of the child node 410-a may produce additional interaction paths (e.g., may be another sub-menu with a list of interaction paths, as described with reference to FIG. 3). Thus, the UI state mapper may generate a child node 410-d, a child node 410-e, and a child node 410-f based on the additional interaction paths.

At 420, the UI state mapper may continue to systematically traverse each of the interaction paths generated by the child node 410-d, the child node 410-e, and the child node 410-f. For example, the UI state mapper may travers from the child node 410-a to the child node 410-d. The feature of the child node 410-d may produce child node 410-g and child node 410-h. The child node 410-g may be the end of the interaction path from the child node 410-d (e.g., the end of a sub-tree generated by the child node 410-d). Once the UI state mapper reaches the end of an interaction path, the UI state mapper may return to a nearest ancestral persistent node. That is, at 425, the UI state mapper may return to the root node 405 to continue mapping the UI states of the web document, because the root node 405 may be a nearest ancestral persistent node for the child node 410-g.

At 430, the UI state mapper may continue to systematically traverse each of the interaction paths generated by the child node 410-d (e.g., to the child node 410-h), and then may continue the process for the child node 410-e, the child node 410-f, the child node 410-b, and the child node 410-c to generate the graphical node representation 435.

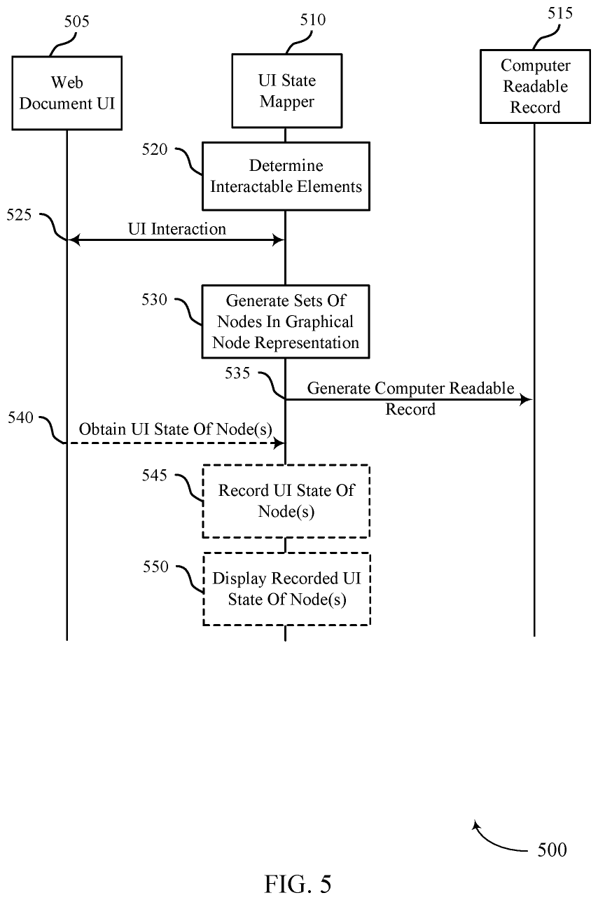

FIG. 5 illustrates an example of a process flow 500 that supports UI state mapping in accordance with aspects of the present disclosure. The process flow 500 includes a web document UI 505, a UI state mapper 510, and a computer readable record 515. These may be examples of the corresponding devices described with reference to FIGS. 1 through 4. The UI state mapper 510 may generate a repeatable graphical node representation of a sequence of interactions with the web document UI 505, which may improve user experience, reduce system latency, and improve user efficiency. Alternative examples of the following may be implemented, where some steps are performed in a different order than described or are not performed at all. In some cases, steps may include additional features not mentioned below, or further steps may be added.

At 520, the UI state mapper 510 may determine a set of interactable elements, or features, that are configured to cause a UI state change to a UI of the web document. For example, the UI state mapper may receive, may be configured with, or may otherwise define a configuration for the web document (e.g., from an API of the web document) that indicates the set of interactable elements.

In some examples, the set of interactable elements may include one or more hidden or nested elements, such as one or more iFrames within the web document, one or more shadow document object model (DOM), or both.

At 525, the UI state mapper 510 may simulate human interaction with a web document UI 505, such as by activating the one or more interactable features. For example, the UI state mapper 510 may cause the web document UI to change URLs, may cause the web document UI to change a visual effect, or the like, by interacting with persistent features and transient features, respectively, of the web document UI 505.

At 530, the UI state mapper 510 may generate sets of nodes in a graphical node representation from the set of interactable elements or features, as described with reference to FIGS. 3 and 4. For example, the graphical node representation may include nodes of a first node type (e.g., persistent nodes) that cause a UI state change from a URL change, nodes of a second node type (e.g., transient nodes) that cause a UI state change from an update to a visual effect on the UI without a URL change.

In some examples, the graphical node representation may include multiple interaction paths (e.g., a first and a second interaction path). For example, if the graphical node representation is a tree data structure, the interaction paths may be sub-trees within the tree data structure. The UI state mapper 510 may traverse the different interaction paths. Once the UI state mapper 510 reaches the end of an interaction path with a transient node, the UI state mapper 510 may return to a nearest ancestral persistent node to continue the mapping, as described with reference to FIG. 4.

At 535, the UI state mapper may generate a computer readable record indicating a sequence of interactions by the UI state mapper 510 to generate the graphical node representation. In some examples, the computer readable record may represent a map that the UI state mapper 510 used to traverse the graphical node representation, such that the UI state mapper 510, another UI state mapper 510, or any other program or user could recreate the sequence of interactions.

In some cases, at 540, the UI state mapper 510 may obtain a record of the UI state of the set of nodes in the graphical node representation. For example, the UI state mapper 510 may obtain respective screenshots for each UI state of the nodes.

At 545, the UI state mapper 510 may record the UI state of one or more nodes in the graphical node representation. For example, the UI state mapper 510 may record the UI states (e.g., screenshots of the UI states) for each interaction of the sequence of interactions when generating the computer readable record.

The UI state mapper 510 may record the UI states at some or all of the nodes of the graphical node representation, which may be a separate data collection operation from generating the graphical node representation. When the UI state mapper 510 records the UI state, that UI state may be linked to the interaction in the sequence of interactions on the computer readable record. For example, if the UI state mapper 510 obtains a screenshot of a UI state, the UI state mapper may record the screenshot as “screenshot X” and a corresponding computer readable record may instruct the UI state mapper 510 how to navigate the graphical node representation to recreate that UI state.

At 550, the UI state mapper 510 may display the UI state to a user, such as via a GUI of a user device. For example, the UI state mapper 510 may display a screenshot of a UI state at a node, such that the user may compare the screenshot to a UI state at a same node for a different web document for localization testing. Additionally, or alternatively, the user may send a user input to the UI state mapper 510 that indicates a privacy status of the node, a security status of the node, an accessibility status of the node, or any combination thereof. For example, the privacy status may indicate whether the node includes private information, the security status may indicate whether the node presents security risks, and the accessibility status may indicate whether the node complies with accessibility regulations. The user, or the UI state mapper 510 (e.g., based on machine learning independent of the user), may flag the nodes based on whether the privacy, security, and/or accessibility conditions of the node. For example, a computer program may scan each recorded UI state (e.g., screenshot) for security, vulnerability, functionality, or accessibility. In some cases, the UI state mapper 510 may record the user input with the UI state of each node.

In some cases, the UI state mapper 510 may determine a duration for traversing at least a portion of the graphical node representation. For example, the UI state mapper 510 may traverse at least a portion of the graphical node representation to obtain an end-to-end execution time for the entire graphical node representation, an interaction path of the graphical node representation, or any other portion of the sequence of interactions by the UI state mapper 510. The UI state mapper 510 may report the duration to a user, store the duration, or may use the duration as input in another process (e.g., a downstream process).

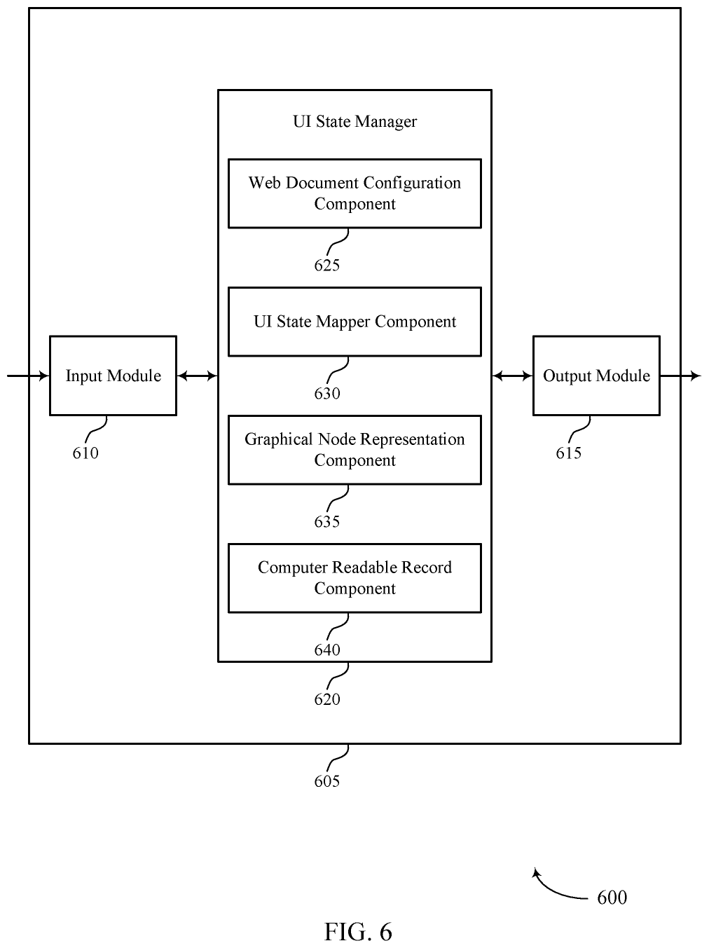

FIG. 6 illustrates a block diagram 600 of a device 605 that supports UI state mapping in accordance with aspects of the present disclosure. The device 605 may include an input module 610, an output module 615, and a UI state manager 620. The device 605 may also include a processor. Each of these components may be in communication with one another (e.g., via one or more buses).

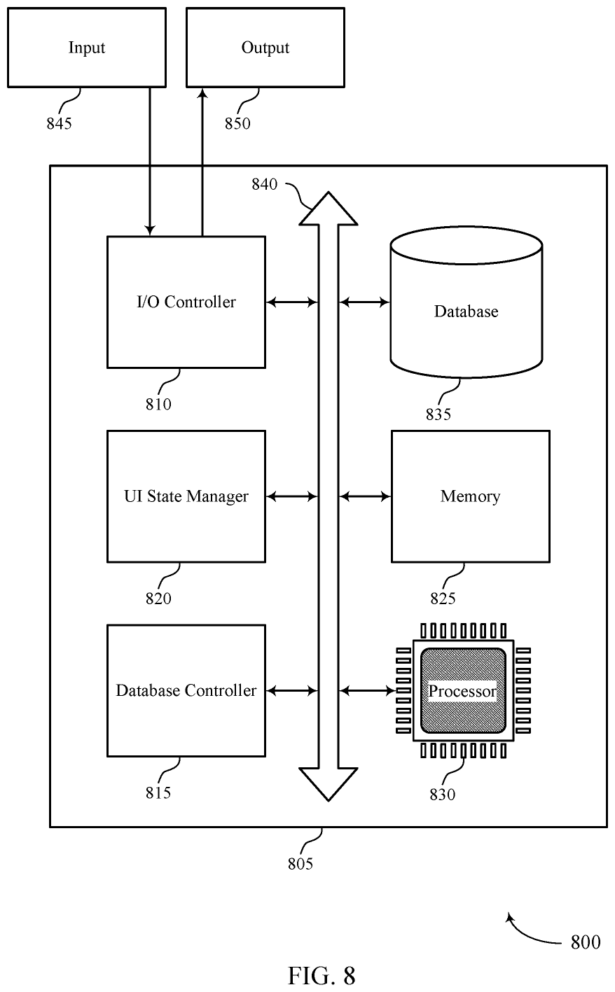

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the UI state manager 620 to support UI state mapping. In some cases, the input module 610 may be a component of an I/O controller 810 as described with reference to FIG. 8.

The output module 615 may manage output signals for the device 605. For example, the output module 615 may receive signals from other components of the device 605, such as the UI state manager 620, and may transmit these signals to other components or devices. In some examples, the output module 615 may transmit output signals for display in a UI, for storage in a database or data store, for further processing at a server or server cluster, or for any other processes at any number of devices or systems. In some cases, the output module 615 may be a component of an I/O controller 810 as described with reference to FIG. 8.

For example, the UI state manager 620 may include a web document configuration component 625, a UI state mapper component 630, a graphical node representation component 635, a computer readable record component 640, or any combination thereof. In some examples, the UI state manager 620, or various components thereof, may be configured to perform various operations (e.g., receiving, monitoring, transmitting) using or otherwise in cooperation with the input module 610, the output module 615, or both. For example, the UI state manager 620 may receive information from the input module 610, send information to the output module 615, or be integrated in combination with the input module 610, the output module 615, or both to receive information, transmit information, or perform various other operations as described herein.

The UI state manager 620 may support mapping UI states in accordance with examples as disclosed herein. The web document configuration component 625 may be configured to support determining, from a configuration corresponding to a web document, a set of interactable elements that are configured to cause a UI state change to a UI of the web document. The UI state mapper component 630 may be configured to support interacting, by a UI state mapper program, with the set of interactable elements of the UI. The graphical node representation component 635 may be configured to support generating, in a graphical node representation and in response to the interacting, a first set of nodes of a first node type and a second set of nodes of a second node type, where the first set of nodes of the first node type correspond to a first UI state change resulting from a URL change, and where the second set of nodes of the second node type correspond to a second UI state change resulting from a visual effect on the UI without a URL change. The computer readable record component 640 may be configured to support generating a computer readable record indicating a sequence of interactions by the UI state mapper program to generate the graphical node representation.

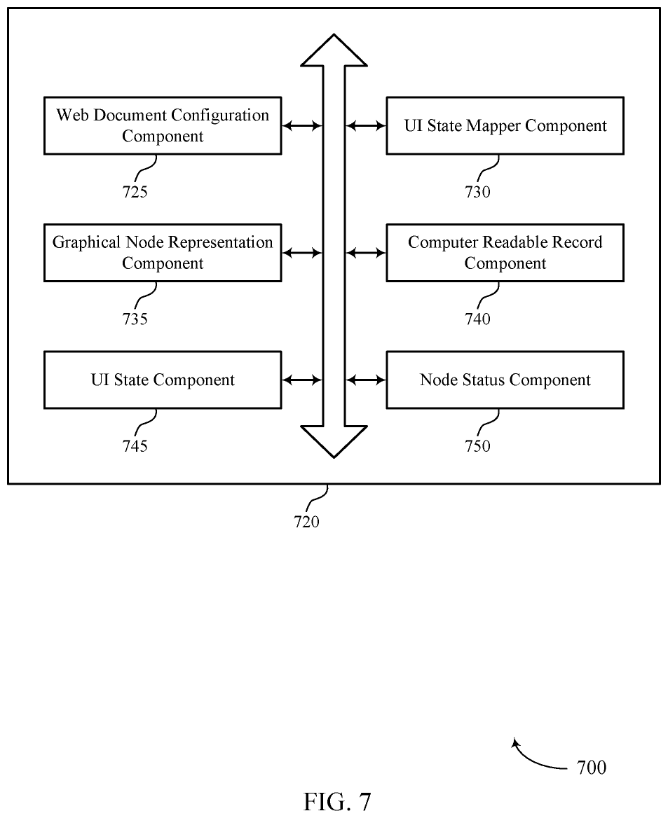

FIG. 7 illustrates a block diagram 700 of a UI state manager 720 that supports UI state mapping in accordance with aspects of the present disclosure. The UI state manager 720 may be an example of aspects of a UI state manager or a UI state manager 620, or both, as described herein. The UI state manager 720, or various components thereof, may be an example of means for performing various aspects of UI state mapping as described herein. For example, the UI state manager 720 may include a web document configuration component 725, a UI state mapper component 730, a graphical node representation component 735, a computer readable record component 740, a UI state component 745, a node status component 750, or any combination thereof. Each of these components may communicate, directly or indirectly, with one another (e.g., via one or more buses).

The UI state manager 720 may support mapping UI states in accordance with examples as disclosed herein. The web document configuration component 725 may be configured to support determining, from a configuration corresponding to a web document, a set of interactable elements that are configured to cause a UI state change to a UI of the web document. The UI state mapper component 730 may be configured to support interacting, by a UI state mapper program, with the set of interactable elements of the UI. The graphical node representation component 735 may be configured to support generating, in a graphical node representation and in response to the interacting, a first set of nodes of a first node type and a second set of nodes of a second node type, where the first set of nodes of the first node type correspond to a first UI state change resulting from a URL change, and where the second set of nodes of the second node type correspond to a second UI state change resulting from a visual effect on the UI without a URL change. The computer readable record component 740 may be configured to support generating a computer readable record indicating a sequence of interactions by the UI state mapper program to generate the graphical node representation.

In some examples, the graphical node representation includes a first interaction path and a second interaction path.

In some examples, to support interacting, the UI state mapper component 730 may be configured to support traversing, by the UI state mapper program, the first interaction path, the first interaction path including at least one node from the second set of nodes. In some examples, to support interacting, the UI state mapper component 730 may be configured to support traversing, by the UI state mapper program, the second interaction path based on returning to a nearest ancestral node of the first node type at an end of the first interaction path.

In some examples, the UI state component 745 may be configured to support recording a UI state of at least one node of the first set of nodes and the second set of nodes in the graphical node representation, where the recorded UI state is associated with a set of interactions of the sequence of interactions indicated by the computer readable record.

In some examples, the UI state component 745 may be configured to support obtaining a screenshot of the UI state of the at least one node. In some examples, the UI state component 745 may be configured to support displaying, via a GUI, the screenshot of the UI state of the at least one node.

In some examples, the UI state component 745 may be configured to support displaying, to a user via a GUI, the recorded UI state of the at least one node. In some examples, the node status component 750 may be configured to support receiving a user input indicating a privacy status of the at least one node, a security status of the at least one node, an accessibility status of the at least one node, or any combination thereof. In some examples, the node status component 750 may be configured to support recording the user input with the UI state of the at least one node.

In some examples, the graphical node representation component 735 may be configured to support traversing at least a portion of the graphical node representation in accordance with the sequence of interactions by the UI state mapper program to generate the graphical node representation. In some examples, the graphical node representation component 735 may be configured to support outputting a duration corresponding to the traversal of at least the portion of the graphical node representation.

In some examples, to support determining the set of interactable elements, the web document configuration component 725 may be configured to support identifying one or more iFrames within the web document, one or more shadow DOMs, or both.

In some examples, the graphical node representation includes a tree data structure.

FIG. 8 illustrates a diagram of a system 800 including a device 805 that supports UI state mapping in accordance with aspects of the present disclosure. The device 805 may be an example of or include the components of a device 605 as described herein. The device 805 may include components for bi-directional data communications including components for transmitting and receiving communications, such as a UI state manager 820, an I/O controller 810, a database controller 815, a memory 825, a processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and ROM. The memory 825 may store computer-readable, computer-executable software including instructions that, when executed, cause the processor 830 to perform various functions described herein. In some cases, the memory 825 may contain, among other things, a BIOS which may control basic hardware or software operation such as the interaction with peripheral components or devices.

The processor 830 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in a memory 825 to perform various functions (e.g., functions or tasks supporting UI state mapping).

The UI state manager 820 may support mapping UI states in accordance with examples as disclosed herein. For example, the UI state manager 820 may be configured to support determining, from a configuration corresponding to a web document, a set of interactable elements that are configured to cause a UI state change to a UI of the web document. The UI state manager 820 may be configured to support interacting, by a UI state mapper program, with the set of interactable elements of the UI. The UI state manager 820 may be configured to support generating, in a graphical node representation and in response to the interacting, a first set of nodes of a first node type and a second set of nodes of a second node type, where the first set of nodes of the first node type correspond to a first UI state change resulting from a URL change, and where the second set of nodes of the second node type correspond to a second UI state change resulting from a visual effect on the UI without a URL change. The UI state manager 820 may be configured to support generating a computer readable record indicating a sequence of interactions by the UI state mapper program to generate the graphical node representation.

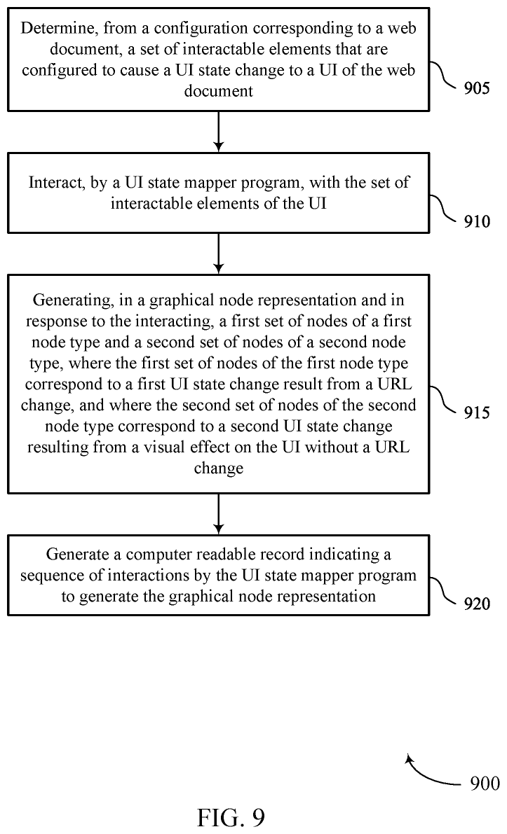

FIG. 9 illustrates a flowchart showing a method 900 that supports UI state mapping in accordance with aspects of the present disclosure. The operations of the method 900 may be implemented by a UI state mapper system or its components as described herein. For example, the operations of the method 900 may be performed by a UI state mapper system as described with reference to FIGS. 1 through 8. In some examples, a UI state mapper system may execute a set of instructions to control the functional elements of the UI state mapper system to perform the described functions. Additionally, or alternatively, the UI state mapper system may perform aspects of the described functions using special-purpose hardware.

At 905, the method may include determining, from a configuration corresponding to a web document, a set of interactable elements that are configured to cause a UI state change to a UI of the web document. The operations of 905 may be performed in accordance with examples as disclosed herein. In some examples, aspects of the operations of 905 may be performed by a web document configuration component 725 as described with reference to FIG. 7.

At 910, the method may include interacting, by a UI state mapper program, with the set of interactable elements of the UI. The operations of 910 may be performed in accordance with examples as disclosed herein. In some examples, aspects of the operations of 910 may be performed by a UI state mapper component 730 as described with reference to FIG. 7.

At 915, the method may include generating, in a graphical node representation and in response to the interacting, a first set of nodes of a first node type and a second set of nodes of a second node type, where the first set of nodes of the first node type correspond to a first UI state change resulting from a URL change, and where the second set of nodes of the second node type correspond to a second UI state change resulting from a visual effect on the UI without a URL change. The operations of 915 may be performed in accordance with examples as disclosed herein. In some examples, aspects of the operations of 915 may be performed by a graphical node representation component 735 as described with reference to FIG. 7.

At 920, the method may include generating a computer readable record indicating a sequence of interactions by the UI state mapper program to generate the graphical node representation. The operations of 920 may be performed in accordance with examples as disclosed herein. In some examples, aspects of the operations of 920 may be performed by a computer readable record component 740 as described with reference to FIG. 7.

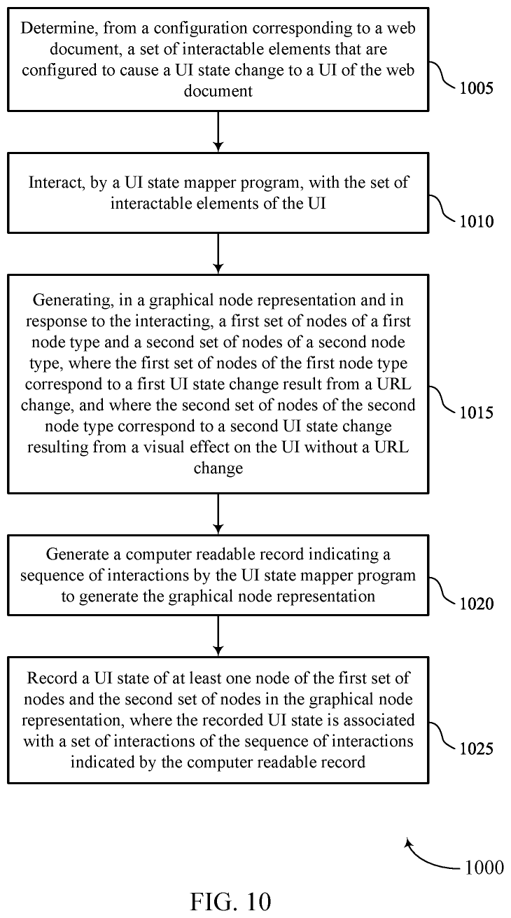

FIG. 10 illustrates a flowchart showing a method 1000 that supports UI state mapping in accordance with aspects of the present disclosure. The operations of the method 1000 may be implemented by a UI state mapper system or its components as described herein. For example, the operations of the method 1000 may be performed by a UI state mapper system as described with reference to FIGS. 1 through 8. In some examples, a UI state mapper system may execute a set of instructions to control the functional elements of the UI state mapper system to perform the described functions. Additionally, or alternatively, the UI state mapper system may perform aspects of the described functions using special-purpose hardware.

At 1005, the method may include determining, from a configuration corresponding to a web document, a set of interactable elements that are configured to cause a UI state change to a UI of the web document. The operations of 1005 may be performed in accordance with examples as disclosed herein. In some examples, aspects of the operations of 1005 may be performed by a web document configuration component 725 as described with reference to FIG. 7.

At 1010, the method may include interacting, by a UI state mapper program, with the set of interactable elements of the UI. The operations of 1010 may be performed in accordance with examples as disclosed herein. In some examples, aspects of the operations of 1010 may be performed by a UI state mapper component 730 as described with reference to FIG. 7.

At 1015, the method may include generating, in a graphical node representation and in response to the interacting, a first set of nodes of a first node type and a second set of nodes of a second node type, where the first set of nodes of the first node type correspond to a first UI state change resulting from a URL change, and where the second set of nodes of the second node type correspond to a second UI state change resulting from a visual effect on the UI without a URL change. The operations of 1015 may be performed in accordance with examples as disclosed herein. In some examples, aspects of the operations of 1015 may be performed by a graphical node representation component 735 as described with reference to FIG. 7.

At 1020, the method may include generating a computer readable record indicating a sequence of interactions by the UI state mapper program to generate the graphical node representation. The operations of 1020 may be performed in accordance with examples as disclosed herein. In some examples, aspects of the operations of 1020 may be performed by a computer readable record component 740 as described with reference to FIG. 7.

At 1025, the method may include recording a UI state of at least one node of the first set of nodes and the second set of nodes in the graphical node representation, where the recorded UI state is associated with a set of interactions of the sequence of interactions indicated by the computer readable record. The operations of 1025 may be performed in accordance with examples as disclosed herein. In some examples, aspects of the operations of 1025 may be performed by a UI state component 745 as described with reference to FIG. 7.

A method for mapping UI states is described. The method may include determining, from a configuration corresponding to a web document, a set of interactable elements that are configured to cause a UI state change to a UI of the web document, interacting, by a UI state mapper program, with the set of interactable elements of the UI, generating, in a graphical node representation and in response to the interacting, a first set of nodes of a first node type and a second set of nodes of a second node type, where the first set of nodes of the first node type correspond to a first UI state change resulting from a URL change, and where the second set of nodes of the second node type correspond to a second UI state change resulting from a visual effect on the UI without a URL change, and generating a computer readable record indicating a sequence of interactions by the UI state mapper program to generate the graphical node representation.

An apparatus for mapping UI states is described. The apparatus may include a processor, memory coupled with the processor, and instructions stored in the memory. The instructions may be executable by the processor to cause the apparatus to determine, from a configuration corresponding to a web document, a set of interactable elements that are configured to cause a UI state change to a UI of the web document, interact, by a UI state mapper program, with the set of interactable elements of the UI, generating, in a graphical node representation and in response to the interacting, a first set of nodes of a first node type and a second set of nodes of a second node type, where the first set of nodes of the first node type correspond to a first UI state change result from a URL change, and where the second set of nodes of the second node type correspond to a second UI state change resulting from a visual effect on the UI without a URL change, and generate a computer readable record indicating a sequence of interactions by the UI state mapper program to generate the graphical node representation.

Another apparatus for mapping UI states is described. The apparatus may include means for determining, from a configuration corresponding to a web document, a set of interactable elements that are configured to cause a UI state change to a UI of the web document, means for interacting, by a UI state mapper program, with the set of interactable elements of the UI, means for generating, in a graphical node representation and in response to the interacting, a first set of nodes of a first node type and a second set of nodes of a second node type, where the first set of nodes of the first node type correspond to a first UI state change resulting from a URL change, and where the second set of nodes of the second node type correspond to a second UI state change resulting from a visual effect on the UI without a URL change, and means for generating a computer readable record indicating a sequence of interactions by the UI state mapper program to generate the graphical node representation.

A non-transitory computer-readable medium storing code for mapping UI states is described. The code may include instructions executable by a processor to determine, from a configuration corresponding to a web document, a set of interactable elements that are configured to cause a UI state change to a UI of the web document, interact, by a UI state mapper program, with the set of interactable elements of the UI, generating, in a graphical node representation and in response to the interacting, a first set of nodes of a first node type and a second set of nodes of a second node type, where the first set of nodes of the first node type correspond to a first UI state change result from a URL change, and where the second set of nodes of the second node type correspond to a second UI state change resulting from a visual effect on the UI without a URL change, and generate a computer readable record indicating a sequence of interactions by the UI state mapper program to generate the graphical node representation.

In some examples of the method, apparatuses, and non-transitory computer-readable medium described herein, the graphical node representation includes a first interaction path and a second interaction path.

In some examples of the method, apparatuses, and non-transitory computer-readable medium described herein, the interacting may include operations, features, means, or instructions for traversing, by the UI state mapper program, the first interaction path, the first interaction path including at least one node from the second set of nodes and traversing, by the UI state mapper program, the second interaction path based on returning to a nearest ancestral node of the first node type at an end of the first interaction path.

Some examples of the method, apparatuses, and non-transitory computer-readable medium described herein may further include operations, features, means, or instructions for recording a UI state of at least one node of the first set of nodes and the second set of nodes in the graphical node representation, where the recorded UI state may be associated with a set of interactions of the sequence of interactions indicated by the computer readable record.

Some examples of the method, apparatuses, and non-transitory computer-readable medium described herein may further include operations, features, means, or instructions for obtaining a screenshot of the UI state of the at least one node and displaying, via a GUI, the screenshot of the UI state of the at least one node.

Some examples of the method, apparatuses, and non-transitory computer-readable medium described herein may further include operations, features, means, or instructions for displaying, to a user via a GUI, the recorded UI state of the at least one node, receiving a user input indicating a privacy status of the at least one node, a security status of the at least one node, an accessibility status of the at least one node, or any combination thereof, and recording the user input with the UI state of the at least one node.

Some examples of the method, apparatuses, and non-transitory computer-readable medium described herein may further include operations, features, means, or instructions for traversing at least a portion of the graphical node representation in accordance with the sequence of interactions by the UI state mapper program to generate the graphical node representation and outputting a duration corresponding to the traversal of at least the portion of the graphical node representation.

In some examples of the method, apparatuses, and non-transitory computer-readable medium described herein, determining the set of interactable elements may include operations, features, means, or instructions for identifying one or more iFrames within the web document, one or more shadow DOMs, or both.

In some examples of the method, apparatuses, and non-transitory computer-readable medium described herein, the graphical node representation includes a tree data structure.

The following provides an overview of aspects of the present disclosure:

Aspect 1: A method for mapping user interface (UI) states, comprising: determining, from a configuration corresponding to a web document, a set of interactable elements that are configured to cause a UI state change to a UI of the web document; interacting, by a UI state mapper program, with the set of interactable elements of the UI; generating, in a graphical node representation and in response to the interacting, a first set of nodes of a first node type and a second set of nodes of a second node type, wherein the first set of nodes of the first node type correspond to a first UI state change resulting from a URL change, and wherein the second set of nodes of the second node type correspond to a second UI state change resulting from a visual effect on the UI without a URL change; and generating a computer readable record indicating a sequence of interactions by the UI state mapper program to generate the graphical node representation.

Aspect 2: The method of aspect 1, wherein the graphical node representation comprises a first interaction path and a second interaction path.

Aspect 3: The method of aspect 2, wherein the interacting comprises: traversing, by the UI state mapper program, the first interaction path, the first interaction path comprising at least one node from the second set of nodes; and traversing, by the UI state mapper program, the second interaction path based at least in part on returning to a nearest ancestral node of the first node type at an end of the first interaction path.

Aspect 4: The method of any of aspects 1 through 3, further comprising: recording a UI state of at least one node of the first set of nodes and the second set of nodes in the graphical node representation, wherein the recorded UI state is associated with a set of interactions of the sequence of interactions indicated by the computer readable record.

Aspect 5: The method of aspect 4, further comprising: obtaining a screenshot of the UI state of the at least one node: and displaying, via a graphical UI, the screenshot of the UI state of the at least one node.

Aspect 6: The method of any of aspects 4 through 5, further comprising: displaying, to a user via a graphical UI, the recorded UI state of the at least one node; receiving a user input indicating a privacy status of the at least one node, a security status of the at least one node, an accessibility status of the at least one node, or any combination thereof: and recording the user input with the UI state of the at least one node.

Aspect 7: The method of any of aspects 1 through 6, further comprising: traversing at least a portion of the graphical node representation in accordance with the sequence of interactions by the UI state mapper program to generate the graphical node representation; and outputting a duration corresponding to the traversal of at least the portion of the graphical node representation.

Aspect 8: The method of any of aspects 1 through 7, wherein determining the set of interactable elements comprises: identifying one or more iFrames within the web document, one or more shadow document object models (DOMs), or both.

Aspect 9: The method of any of aspects 1 through 8, wherein the graphical node representation comprises a tree data structure.

Aspect 10: An apparatus for mapping user interface (UI) states, comprising a processor: memory coupled with the processor: and instructions stored in the memory and executable by the processor to cause the apparatus to perform a method of any of aspects 1 through 9.

Aspect 11: An apparatus for mapping user interface (UI) states, comprising at least one means for performing a method of any of aspects 1 through 9.

Aspect 12: A non-transitory computer-readable medium storing code for mapping user interface (UI) states, the code comprising instructions executable by a processor to perform a method of any of aspects 1 through 9.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for mapping user interface (UI) states, comprising:
determining, from a configuration corresponding to a web document, a set of interactable elements that are configured to cause a UI state change to a UI of the web document;
interacting, by a UI state mapper program, with the set of interactable elements of the UI;
generating, in a graphical node representation and in response to the interacting, a first set of nodes of a first node type and a second set of nodes of a second node type, wherein the first set of nodes of the first node type correspond to a first UI state change resulting from a universal resource locator (URL) change, and wherein the second set of nodes of the second node type correspond to a second UI state change resulting from a visual effect on the UI without a URL change; and
generating a computer readable record indicating a sequence of interactions by the UI state mapper program to generate the graphical node representation.

2. The method of claim 1, wherein the graphical node representation comprises a first interaction path and a second interaction path.

3. The method of claim 2, wherein the interacting comprises:
traversing, by the UI state mapper program, the first interaction path, the first interaction path comprising at least one node from the second set of nodes; and
traversing, by the UI state mapper program, the second interaction path based at least in part on returning to a nearest ancestral node of the first node type at an end of the first interaction path.

4. The method of claim 1, further comprising:
recording a UI state of at least one node of the first set of nodes and the second set of nodes in the graphical node representation, wherein the recorded UI state is associated with a set of interactions of the sequence of interactions indicated by the computer readable record.

5. The method of claim 4, further comprising:
obtaining a screenshot of the UI state of the at least one node; and
displaying, via a graphical UI, the screenshot of the UI state of the at least one node.

6. The method of claim 4, further comprising:
displaying, to a user via a graphical UI, the recorded UI state of the at least one node;
receiving a user input indicating a privacy status of the at least one node, a security status of the at least one node, an accessibility status of the at least one node, or any combination thereof; and
recording the user input with the UI state of the at least one node.

7. The method of claim 1, further comprising:
traversing at least a portion of the graphical node representation in accordance with the sequence of interactions by the UI state mapper program to generate the graphical node representation; and
outputting a duration corresponding to the traversal of at least the portion of the graphical node representation.

8. The method of claim 1, wherein determining the set of interactable elements comprises:
identifying one or more iFrames within the web document, one or more shadow document object models (DOMs), or both.

9. The method of claim 1, wherein the graphical node representation comprises a tree data structure.

10. An apparatus for mapping user interface (UI) states, comprising:
a processor;
memory coupled with the processor; and
instructions stored in the memory and executable by the processor to cause the apparatus to:
determine, from a configuration corresponding to a web document, a set of interactable elements that are configured to cause a UI state change to a UI of the web document;
interact, by a UI state mapper program, with the set of interactable elements of the UI;
generate, in a graphical node representation and in response to the interacting, a first set of nodes of a first node type and a second set of nodes of a second node type, wherein the first set of nodes of the first node type correspond to a first UI state change result from a universal resource locator (URL) change, and wherein the second set of nodes of the second node type correspond to a second UI state change resulting from a visual effect on the UI without a URL change; and
generate a computer readable record indicating a sequence of interactions by the UI state mapper program to generate the graphical node representation.

11. The apparatus of claim 10, wherein the graphical node representation comprises a first interaction path and a second interaction path.

12. The apparatus of claim 11, wherein the instructions to interact are executable by the processor to cause the apparatus to:
traverse, by the UI state mapper program, the first interaction path, the first interaction path comprising at least one node from the second set of nodes; and
traverse, by the UI state mapper program, the second interaction path based at least in part on returning to a nearest ancestral node of the first node type at an end of the first interaction path.

13. The apparatus of claim 10, wherein the instructions are further executable by the processor to cause the apparatus to:
record a UI state of at least one node of the first set of nodes and the second set of nodes in the graphical node representation, wherein the recorded UI state is associated with a set of interactions of the sequence of interactions indicated by the computer readable record.

14. The apparatus of claim 13, wherein the instructions are further executable by the processor to cause the apparatus to:
obtain a screenshot of the UI state of the at least one node; and
display, via a graphical user interface, the screenshot of the UI state of the at least one node.

15. The apparatus of claim 13, wherein the instructions are further executable by the processor to cause the apparatus to:
display, to a user via a graphical UI, the recorded UI state of the at least one node;
receive a user input indicating a privacy status of the at least one node, a security status of the at least one node, an accessibility status of the at least one node, or any combination thereof; and
record the user input with the UI state of the at least one node.

16. The apparatus of claim 10, wherein the instructions are further executable by the processor to cause the apparatus to:
traverse at least a portion of the graphical node representation in accordance with the sequence of interactions by the UI state mapper program to generate the graphical node representation; and
output a duration corresponding to the traversal of at least the portion of the graphical node representation.

17. The apparatus of claim 10, wherein the instructions to determine the set of interactable elements are executable by the processor to cause the apparatus to:
identify one or more iFrames within the web document, one or more shadow document object models (DOMs), or both.

18. The apparatus of claim 10, wherein the graphical node representation comprises a tree data structure.

19. A non-transitory computer-readable medium storing code for mapping user interface (UI) states, the code comprising instructions executable by a processor to:
determine, from a configuration corresponding to a web document, a set of interactable elements that are configured to cause a UI state change to a UI of the web document;
interact, by a UI state mapper program, with the set of interactable elements of the UI;
generate, in a graphical node representation and in response to the interacting, a first set of nodes of a first node type and a second set of nodes of a second node type, wherein the first set of nodes of the first node type correspond to a first UI state change result from a universal resource locator (URL) change, and wherein the second set of nodes of the second node type correspond to a second UI state change resulting from a visual effect on the UI without a URL change; and
generate a computer readable record indicating a sequence of interactions by the UI state mapper program to generate the graphical node representation.

20. The non-transitory computer-readable medium of claim 19, wherein the graphical node representation comprises a first interaction path and a second interaction path.
